(19) United States
(12) Patent Application Publication
(10) Pub. No.: US 2003/0201988 A1
(43) Pub. Date: Oct. 30, 2003

(54) Selectively activating display column sections

(76) Inventor: Mary E. Swallow, Tempe, AZ (US)

Correspondence Address: Timothy N. Trop, TROP, PRUNER & HU, P.C., STE. 100, 8554 KATY FWY., HOUSTON, TX, 77024-1805, US

(21) Appl. No.: 10/453,945

(22) Filed: Jun. 4, 2003

Related U.S. Application Data
(62) Division of application No. 09/727,040, filed on Nov. 30, 2000, now Pat. No. 6,605,903.

(51) Int. Cl. G09G 5/00

(52) U.S. Cl. 345/204

(57) ABSTRACT

A light emitting display may include cathode columns with a folded arrangement so that each column includes two selectively activatable sections. Each column section may be selectively activated or deactivated depending on whether defects are associated with a given section.

### BACKGROUND

This invention relates generally to displays for processor-based systems and appliances.

Emissive displays include light emitting devices that emit light in response to a potential. In one embodiment, each pixel may be formed of an organic light emitting device. The organic light emitting device may emit light associated with a particular color in a color gamut. Alternatively, a filter may be used to produce a desired light color.

Polymer displays or organic light emitting displays use layers of light emitting polymers. Unlike liquid crystal devices, the polymer displays actually emit light. Light emission may be advantageous for many applications.

Generally, polymer displays use at least one semiconductor conjugated polymer sandwiched between a pair of contact layers. The contact layers produce an electric field which injects charge carriers into the polymer layer. When the charge carriers combine in the polymer layer, the charge carriers decay and emit radiation in the visible range.

One semiconductive conjugated polymer that may be used in polymer displays is poly(p-phenylenevinylene) (PPV) which emits green light. Another polymer that emits red-orange light is poly(methylethylhexyloxy-p-phenylenevinylene) (MEH-PPV). Other polymers of this class are also capable of emitting blue light. In addition nitrile substituted conjugated polymers may be used in forming polymer displays.

Active matrix polymer displays may be formed from a substrate such as glass or metal foil covered with an array of active elements. In one conventional structure, the active elements may be thin film transistors (TFTs). In contrast, in passive matrix displays, thin film transistors may be unnecessary. Generally, an entire column is activated at a time and row signals are then sequentially applied to that column.

In a number of cases, individual pixels forming an array of light emitting devices may be defective. The pixels may be defective because of improper formation, contamination, or other defects. Commonly, if the defect rate is too high, the entire display may be discarded.

Thus, there is a need for ways to make displays in a more economical fashion.

### BRIEF DESCRIPTION OF THE DRAWINGS

FIG. 1 is a bottom plan view of one embodiment of the present invention; and

FIG. 2 is an enlarged, schematic cross-sectional view taken generally along the lines 2-2 in FIG. 1 in accordance with one embodiment of the present invention.

### DETAILED DESCRIPTION

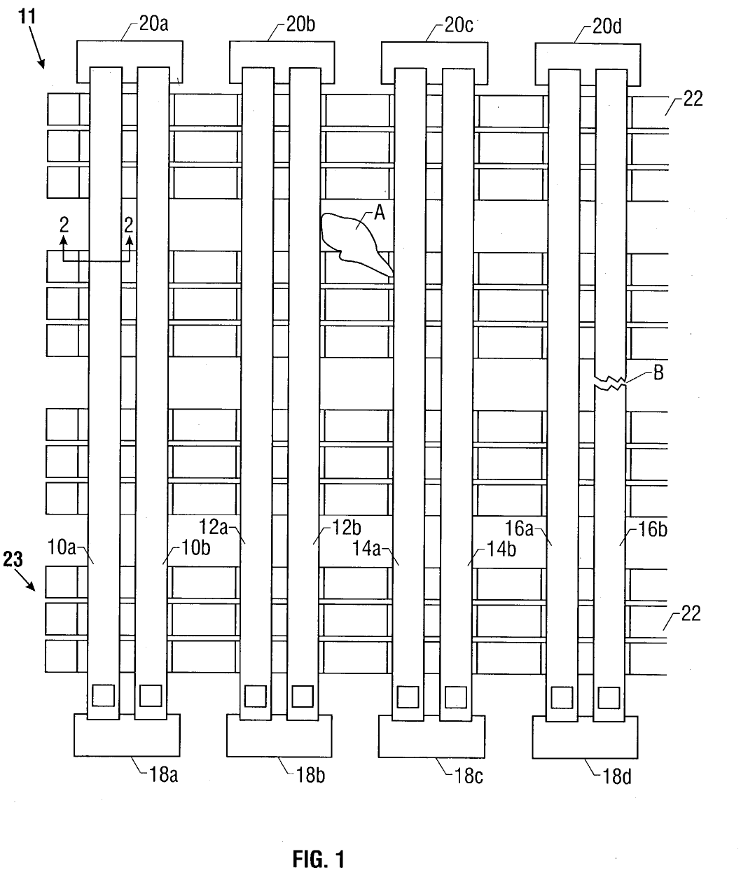

Referring to FIG. 1, the backside of a display 11 may be made up of a plurality of cathode columns 10, 12, 14 and 16 that run in a first direction and a plurality of anode rows 22 which extend generally transversely thereto. Each set 23 of three rows 22 may form a pixel that emits three different colors to form an appropriate color gamut. In the illustrated embodiment, each color is produced by a light emitting device arranged at the intersection of a column 10, 12, 14 or 16 and a row 22. In other embodiments, other layouts may be possible.

Each pixel is formed in the region where a cathode column 10, 12, 14 or 16 overlays an anode row 22. When appropriate potentials are applied between the cathode 10, 12, 14 or 16 and an anode row 22, light is emitted into the page in FIG. 1.

In one embodiment of the present invention, the cathode columns 10, 12, 14 and 16 may be formed of aluminum. The rows 22 may be formed of indium tin oxide (ITO) so that they are both conductive and substantially light transmissive.

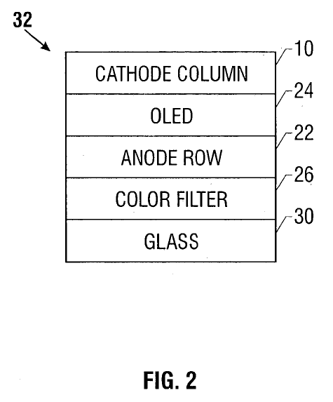

Referring to FIG. 2, a pixel 32 of a passive matrix light emitting device includes a cathode column 10 and an anode row 22 that sandwich a light emitting layer 24. In one embodiment of the present invention, the layer 24 may be an organic light emitting device (OLED). When appropriate potentials are applied between the cathode column 10 and anode row 22, light is emitted by the light emitting layer 24 and that light passes through the substantially transparent anode 22. That light is then filtered, in some embodiments, by a color filter 26 to produce a desired color of light. In some cases, the light emitting layer 24 may not produce the exact color which is appropriate for a particular color gamut. The emitted color may be altered by using a color filter 26 in some embodiments. Light then passes through the glass substrate 30.

Referring back to FIG. 1, each column 10, 12, 14 and 16 includes a pair of selectively coupled sections 10a and lob, 12a and 12b, 14a and 14b and 16a and 16b. In effect, each column 10-16 has a folded architecture to form a pair of sections such as the sections 10a and 10b. Each pair of sections may be joined by a selector 20 at one end of a column 10-16 and by a multiplexer 18 on the other end. The multiplexer 18 provides a potential to one or both of the sections of a pair and the selector 20 selectively joins the pair of sections or it leaves them unjoined.

Referring to the sections 12b and 14a, a conductive particle A is causing the two sections 12b and 14a to short to one another. In such case, the column 12b may not be driven while the column 12a is driven under control of the multiplexer 18b. At the same time, the selector 20b is deselected so that a potential is only applied to the column 12a. Likewise, with respect to the column 14, the multiplexer 18c only drives the section 14b and the selector 20c does not join the sections 14a and 14b.

Conversely with respect to the column 10, there are no defects and therefore either or both sections 10a and 10b may be driven by the multiplexer 18a. The selector 20 joins the columns 10a and 10b to produce a folded, unitary column 10.

Finally, referring to the column 16, a column open B is present in the section 16b. In such case, the multiplexer 18d may drive only the section 16a and the selector 20d deselects the section 16b. Alternatively, both columns 16a and 16b may be driven but the column 16b may be isolated or deselected by the selector 20d. In this way, the section 16b of a folded column 16 may be deselected while the remainder of the folded column (the section 16a) may still be used. In some cases, additional or redundant columns or column sections may be provided to enable a display to still be useful even when a substantial number of defects are detected.

Defects may be detected in post-manufacturing examinations as one example. Once the defects are detected, rather than discarding the display 11, the multiplexers 18 and the selectors 20 may be programmed to deactivate the affected sections. The multiplexers 18 and the selectors 20 may be controlled through appropriate electrical signals provided from a controller associated with the display 11. Alternatively, the selectors 20 and multiplexers 18 may be mask programmed, for example using laser light to cut or make connections. As still another alternative, the selectors 20 and multiplexers 18 may be programmed by selectively blowing fuses. In mask programming or fuse programming embodiments, a plurality of conductive paths may be selectably programmed to either connect the sections of a given column or to prevent them from being connected and to either provide a potential to a given section or to prevent the provision of such a potential to a particular section.

Because the folded sections that form the columns 1016 are placed relatively close together, the fact that one section does not work may not be noticeable to a user since each section is responsible for a relatively minute portion of the light produced by the overall display 11. Thus, in some embodiments, a folded architecture may enable sections which may or may not be redundant, to be selectively activated depending on the nature of defects associated with any particular section.

While the present invention has been described with respect to an embodiment using organic light emitting devices, other displays may be implemented using the techniques described herein including those that utilize liquid crystal displays (LDCs) and inorganic light emitting devices.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
determining whether a defect is associated with one of two sections of a cathode column of a display; and
if a defect is associated with one of the sections, deselecting the section.

2. The method of claim 1 including providing a pair of sections for each column.

3. The method of claim 2 including providing a multiplexer for each column to selectively drive each of the sections making up the column.

4. The method of claim 3 including providing a selector in each column to selectively couple the sections of a column together depending on whether a section is associated with a defect.

5. The method of claim 1 including applying a potential to an organic light emitting device through said cathode column and an anode row.

6. The method of claim 5 including programming said multiplexer and said selector to deactivate a section associated with a defect.

7. The method of claim 6 including continuing to use one section of a column while the other section of a column is deactivated.

8. The method of claim 7 including mask programming said multiplexer.

9. The method of claim 8 including mask programming said selector.

10. The method of claim 1 including providing two sections to form each cathode, each of said sections having a pair of opposed ends, and selectively joining said opposed ends to create a unitary column depending on whether or not there is a defect associated with one of said sections.

11. A display comprising:
a cathode including a pair of sections; and
a device to selectively couple said cathode sections together.

12. The display of claim 11 including a plurality of anode rows extending generally transversely to said cathode.

13. The display of claim 12 wherein said cathode rows are substantially transparent.

14. The display of claim 11 wherein said display includes an organic light emitting device.

15. The display of claim 14 wherein the organic light emitting device is positioned between said cathode and said anode row.

16. The display of claim 11 wherein said display is a passive matrix display.

17. The display of claim 11, said sections having ends, and including a selector which selectively couples the ends of said sections.

18. The display of claim 11 including a multiplexer that selectively drives one or both of said sections.

19. The display of claim 18 wherein said multiplexer is mask programmable.

20. The display of claim 18 wherein said selector is mask programmable.

21. The display of claim 11 wherein the cathode includes a pair of parallel sections, said parallel section being arranged transversely to a plurality of anode rows, a set of three anode rows defining a pixel, the pixel including at least three color producing light emitting devices.

22. An organic light emitting device comprising:
a cathode column including a pair of sections, each section including a pair of opposed ends;
a first device to selectively couple one of the ends of each section together;
second device to selectively drive the other of the ends of each section; and
a plurality of substantially transparent anode rows arranged generally transversely to said cathode column.

23. The device of claim 22 including a set of three anode rows and an organic light emitting material between said anode rows and said cathode column such than when an appropriate potential is applied between said column and said rows, said material emits light through said anode rows.

24. The device of claim 23 wherein said device is a passive matrix display.

25. The device of claim 22 wherein one section may be selectively driven when another section is not driven.
